(19) United States
(12) Patent Application Publication
(10) Pub. No.: US 2026/0175345 A1
(43) Pub. Date: Jun. 25, 2026

(54) MULTI-BEARING GRINDING DEVICE AND COFFEE MACHINE

(71) Applicant: DANPING LIU, Shenzhen City, Guangdong Province (CN)

(72) Inventor: DANPING LIU, Shenzhen City, Guangdong Province (CN)

(21) Appl. No.: 19/124,884

(22) PCT Filed: Jun. 2, 2023
(86) PCT No.: PCT/CN2023/098101

§ 371 Date: Apr. 27, 2025

(51) Int. Cl. B24B 5/12; A47J 31/42; A47J 42/50; B24B 5/04; B24B 7/18; B24B 7/22; B24B 9/10

(52) U.S. Cl. CPC B24B 5/12; A47J 31/42; A47J 42/50; B24B 5/04; B24B 7/186; B24B 7/228; B24B 9/102

(57) ABSTRACT

A multi-bearing grinding device includes a grinding cavity, a driving assembly and a grinding assembly, the grinding assembly is arranged in the grinding chamber and includes a grinding wheel and a grinding head which cooperate with each other, the driving assembly includes a power unit and a driving shaft, an output end of the power unit is connected to the driving shaft, the driving shaft drives the grinding head to rotate, a first bearing and a second bearing are sleeved on the driving shaft between one side of the grinding head and the power unit, and a third bearing is sleeved on the driving shaft and located on the other side of the grinding head. A coffee machine includes the multi-bearing grinding device, and a storage chamber and a powder bin which are provided on two sides of the multi-bearing grinding device in communication with the multi-bearing grinding device.

### TECHNICAL FIELD OF THE INVENTION

The present invention relates to the field of a coffee equipment, and more particularly, to a multi-bearing grinding device and a coffee machine.

### BACKGROUND OF THE INVENTION

The portable coffee bean grinders currently on the market generally include a grinding assembly with a conical grinding head. Usually only on one side of the conical grinding head is positioned while the other side is not positioned. A great squeezing force is applied to the conical grinding head to grind the coffee beans, such grinding assembly with the conical grinding head positioned on one side is easy to cause an unbalanced squeezing force, so that the grinding head will deviate from the center during the grinding process, resulting in uneven grinding and uneven powder output. In addition, long-term eccentric grinding will cause the grinding assembly to be easily damaged and the performance of the grinder to be unstable.

Therefore, it is necessary to provide a grinding device with a stable structure, precise positioning, uniform grinding and stable performance.

### TECHNICAL QUESTION

An object of the present invention is to provide a multi-bearing grinding device with a stable structure and uniform grinding, and a coffee machine having the grinding device with uniform powder output and stable performance.

### Technical Solutions

To obtain the object of the present invention, the following technical solutions are provided:

the present invention provides a multi-bearing grinding device, which a grinding chamber, a drive assembly, and a grinding assembly; the grinding assembly is arranged in the grinding chamber, the grinding assembly comprises a grinding wheel and a grinding head that cooperate with each other to obtain grinding, the drive assembly comprises a power unit and a drive shaft, an output end of the power unit is connected to the drive shaft, the drive shaft is connected to and drives the grinding head to rotate, a first bearing and a second bearing are sleeved on the drive shaft between one side of the grinding head and the power unit, and a third bearing is sleeved on the drive shaft at the other side of the grinding head.

In the technical solution of the present invention, the second bearing and the third bearing are arranged on both sides of the grinding head, which can realize a precise positioning of the grinding head, maintain a coaxiality of the grinding head and the grinding wheel, realize precision grinding, and achieve grinding ultrafine powder and ensure the uniformity of powder output. At the same time, the first bearing is arranged as a flat thrust bearing, which can withstand the axial downward pressure, reduce friction, and maximize the kinetic energy efficiency.

In some embodiments, the grinding chamber comprises a first grinding shell, the grinding wheel and the grinding head are arranged in the first grinding shell, and the first bearing is arranged between the power unit and the first grinding shell.

In some embodiments, the first grinding shell is provided with a bearing support, and a center of the bearing support defines an opening through which the drive shaft passes. The bearing support forms a first bearing cavity at a side close to the power unit, and the first bearing is located in the first bearing cavity.

In some embodiments, the bearing support further comprises a second bearing cavity at a side close to the grinding head, the second bearing is located in the second bearing cavity, and the second bearing is located between the bearing support and the grinding head.

In some embodiments, the first grinding shell forms a conical concave surface on a side thereof close to the power unit, a center of the conical concave surface defines a first through hole for the drive shaft and the grinding head to pass through, and the bearing support extends upward from a bottom side of the conical concave surface at an outer circumference of the first through hole. The configuration of the conical concave surface can reduce the space and make the structure of the first grinding shell more compact.

In some embodiments, the grinding wheel is arranged on the lower side of the conical concave surface of the first grinding shell and is fixed in the first grinding shell.

In some embodiments, the grinding chamber further comprises a second grinding shell, and the second grinding shell is sleeved outside the first grinding shell.

In some embodiments, a mounting bracket is formed in the second grinding shell, the power unit is fixedly mounted on the mounting bracket, an axial hole is defined in a center of the mounting bracket, and the output end of the power unit and the drive shaft pass through the axial hole.

In some embodiments, the grinding chamber further comprises a grinding bottom shell, a bottom of the first grinding shell is mounted in cooperation with the grinding bottom shell.

In some embodiments, the grinding wheel is fixedly mounted between the first grinding shell and the grinding bottom shell.

In some embodiments, the grinding bottom shell forms an annular first boss and an annular second boss, the second boss is provided in a middle of the first boss, and a through hole is provided in a center of the second boss for allowing the drive shaft to pass through.

In some embodiments, a third bearing cavity is formed in a middle of the second boss, and the third bearing is arranged in the third bearing cavity.

In some embodiments, the grinding bottom shell is provided with mounting columns along an outer periphery of the first boss, the first grinding shell defines first mounting holes, the second grinding shell is provided with the mounting bracket, and each mounting column passes through each first mounting hole and cooperate with the mounting bracket of the second grinding shell to be fixed.

In some embodiments, the grinding head is a conical structure, and diameters of the grinding head of a side close to the drive assembly are smaller than diameters of a side away from the drive assembly. By adjusting an axial position of the grinding head in the grinding wheel, a gap between inner grinding teeth and outer grinding teeth can be adjusted, thereby adjusting the grinding particle size.

In some embodiments, the grinding assembly further comprises an adjusting nut, and an end of the drive shaft extending outside the grinding head is provided with external threads, which cooperate with the adjusting nut. Thereby, the gap between the inner grinding teeth and the outer grinding teeth is adjusted, and the grinding particle size is adjusted.

In some embodiments, an elastic member is sleeved on the drive shaft between the grinding head and the power unit to maintain a stability of the grinding head. When the adjusting nut adjusts its axial position, the elastic member is elastically adjusted accordingly, thereby maintaining a stable positioning of the grinding head and a stable cooperation between the grinding head and the grinding wheel.

In some embodiments, the grinding chamber further comprises a drive housing, the drive housing is fixedly mounted on the mounting bracket, and the power unit is arranged in the drive housing.

In some embodiments, the grinding chamber further comprises a third grinding shell, and the third grinding shell is sleeved outside the first grinding shell and the second grinding shell.

In some embodiments, the multi-bearing grinding device further comprises a control assembly, which is disposed in the grinding chamber.

In some embodiments, the control assembly includes a control circuit module and a power module, and the control circuit module and the power module are arranged around a periphery of the grinding wheel.

In some embodiments, the control circuit module comprises an annular PCB, and the annular PCB is installed around the grinding wheel.

The present invention also provides a coffee machine, which includes the multi-bearing grinding device as described above, a storage chamber and a powder bin, wherein the storage chamber and the powder bin are respectively arranged on both sides of the grinding chamber and are connected and installed with the grinding chamber, and the storage chamber and the powder bin are communicated with the grinding chamber.

In some embodiments, the drive assembly is arranged in the storage chamber, and a bean storage space for placing coffee beans is reserved in the storage chamber. The coffee machine of the present invention arranges the drive assembly in the storage chamber, and the drive assembly can be highly integrated and only takes up a small space.

In some embodiments, the drive assembly is placed in the center of the storage chamber, and the bean storage space includes an annular space surrounding the drive assembly. When the drive assembly is placed in the center of the storage chamber, it can be directly connected to and drive the grinding assembly, reducing some parts required for power transmission and conversion, making the structure more compact, the drive assembly and the grinding assembly occupy less space, and the space utilization rate is higher.

In some embodiments, the drive assembly includes a drive motor longitudinally arranged in the storage chamber, and the drive motor is arranged along the same axis as the drive shaft.

In some embodiments, the storage chamber includes a storage shell and a storage cover, and the storage shell is installed in cooperation with the first grinding shell or the second grinding shell. The bean storage space is formed between the storage shell and the drive assembly, and the storage cover is detachably installed at one end of the storage shell. In some embodiments, the storage shell can be made of transparent or translucent material, which makes it easier to observe the amount of remaining coffee beans.

In some embodiments, the powder bin includes a powder bin shell, and the powder bin shell is installed in cooperation with the first grinding shell.

### Advantages

Compared with the prior art, the present invention has the following advantages:
the grinding device of the present invention is provided with a first bearing, a second bearing and a third bearing, and specifically, bearings are located at both sides of the grinding head, which can realize a precise positioning of the grinding head, maintain the coaxiality of the grinding head and the grinding wheel, realize precision grinding, and can achieve grinding ultrafine powder and ensure the uniformity of powder output. At the same time, the first bearing is set as a flat thrust bearing, which can withstand an axial downward pressure, reduce friction, and maximize the kinetic energy efficiency.

The coffee machine of the present invention arranges the drive assembly in the storage chamber, and the output end thereof can be directly connected to the grinding assembly in the grinding chamber, so that the drive assembly can be highly integrated and only occupies a very small space. Then, the other larger space in the storage chamber can be fully utilized to place coffee beans, thereby maximizing the use of space and adding coffee beans more simple and easier.

### BRIEF DESCRIPTION OF DRAWINGS

FIG. 1 illustrates a first exploded view of a coffee machine and a multi-bearing grinding device thereof of the present invention;

FIG. 2 illustrates a second exploded view of the coffee machine and the multi-bearing grinding device thereof of the present invention;

FIG. 3 illustrates a first view of an appearance of the coffee machine of the present invention;

FIG. 4 illustrates a second view of the appearance of the coffee machine of the present invention;

FIG. 5 illustrates a cross-sectional view in a direction of A of FIG. 3;

FIG. 6 illustrates a cross-sectional view in a direction of B of FIG. 4; and

FIG. 7 illustrates a perspective view of the coffee machine of the present invention.

### DETAILED DESCRIPTION OF THE INVENTION

The exemplary embodiments of the present invention will be described in more detail below with reference to the accompanying drawings. Although the exemplary embodiments of the present invention are shown in the accompanying drawings, it should be understood that the present invention can be implemented in various forms and should not be limited by the embodiments described herein. On the contrary, these embodiments are provided in order to enable a more thorough understanding of the present invention and to fully convey the scope of the present invention to those skilled in the art.

It should be understood that the terms used herein are for the purpose of describing specific exemplary embodiments only and are not intended to be limiting. Unless the context clearly indicates otherwise, the singular forms “a”, “an”, and “the” as used herein may also be meant to include the plural forms. The terms “comprise”, “include”, “contain”, and “have” are inclusive and therefore specify the presence of the stated features, steps, operations, elements, and/or parts, but do not exclude the presence or addition of one or more other features, steps, operations, elements, parts, and/or combinations thereof. The method steps, processes, and operations described herein are not to be construed as necessarily requiring them to be performed in the specific order described or illustrated, unless the order of execution is explicitly indicated. It should also be understood that additional or alternative steps may be used.

Although the terms first, second, third, etc. can be used in the text to describe multiple elements, components, regions, layers and/or sections, these elements, components, regions, layers and/or sections should not be limited by these terms. These terms can only be used to distinguish an element, component, region, layer or section from another region, layer or section. Unless the context clearly indicates, terms such as “first”, “second” and other numerical terms do not imply order or sequence when used in the text. Therefore, the first element, component, region, layer or section discussed below can be referred to as the second element, component, region, layer or section without departing from the teaching of the example embodiments.

For ease of description, spatial relative terms may be used herein to describe the relationship of one element or feature relative to another element or feature as shown in the figure, such as “inside”, “outside”, “inner side”, “outer side”, “below”, “under”, “above”, “on”, “front end”, “rear side”, etc. Such spatial relative terms are intended to include different orientations of the device in use or operation in addition to the orientation depicted in the figure. For example, if the device in the figure is turned over, then the element described as “below other elements or features” or “under other elements or features” will subsequently be oriented as “above other elements or features” or “on other elements or features”. Thus, the example term “below” can encompass both an orientation of above and below. The device may be otherwise oriented (rotated 90 degrees or at other orientations) and the spatially relative descriptors used herein interpreted accordingly.

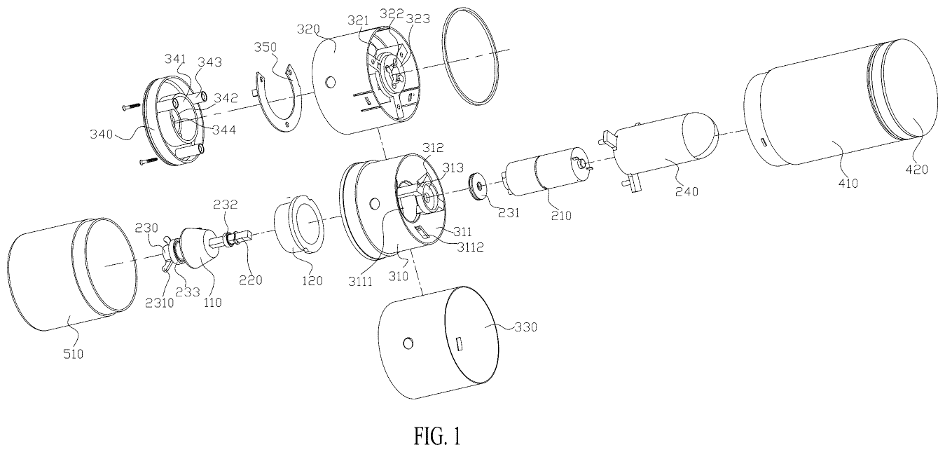

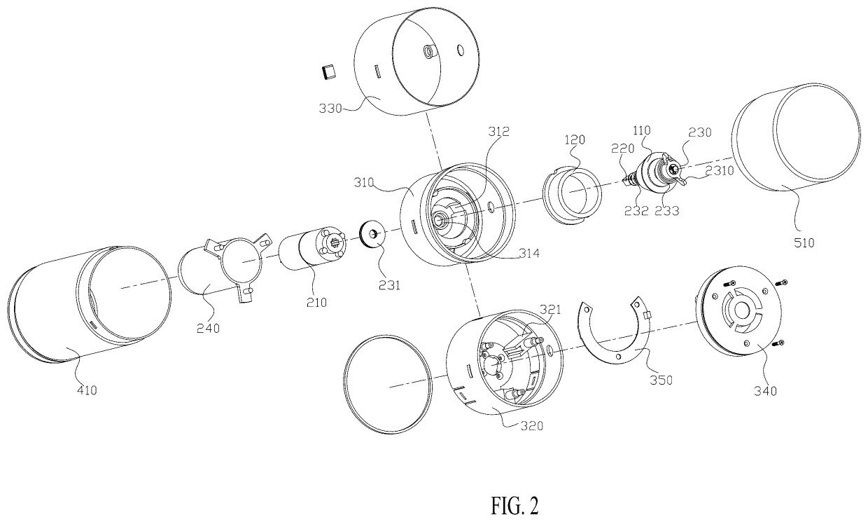

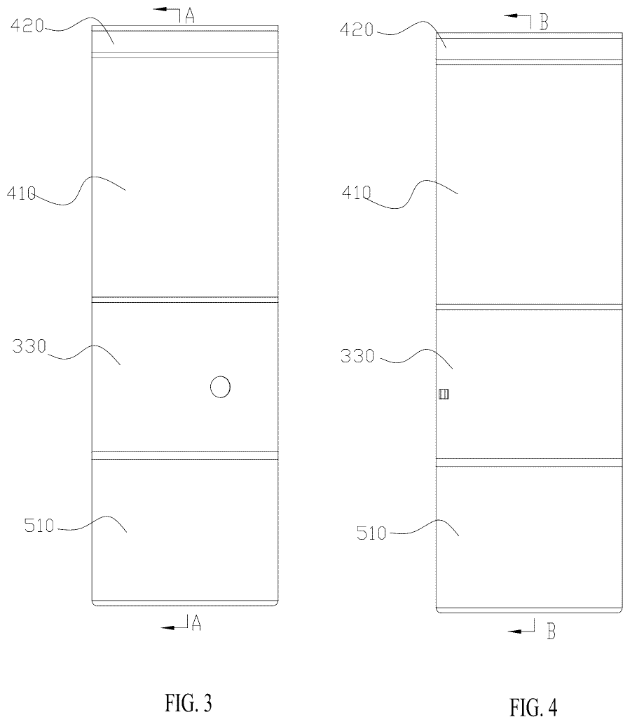

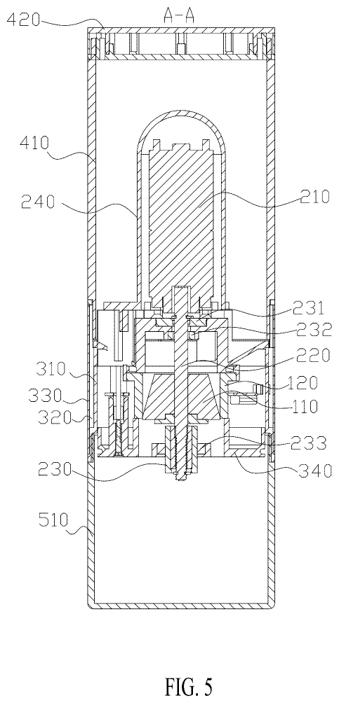

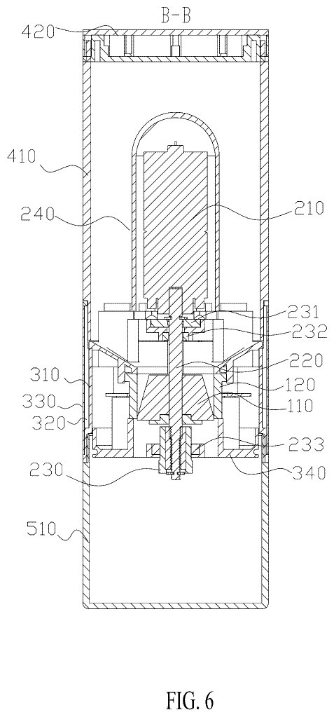

Please refer to FIGS. 1 to 6, the multi-bearing grinding device of the present invention includes a grinding chamber, a drive assembly, and a grinding assembly. The grinding assembly is arranged in the grinding chamber. The grinding assembly includes a grinding wheel 120 and a grinding head 110 that cooperate with each other to achieve grinding. The drive assembly includes a power unit and a drive shaft 220. In a specific embodiment, the power unit includes a driving motor 210.

An output end of the power unit is coupled to the drive shaft 220. Specifically, the output end of the driving motor 210 is coupled to the drive shaft 220. The drive shaft 220 is connected to and drives the grinding head 110 to rotate. A first bearing 231 and a second bearing 232 are sleeved on the drive shaft 220 between one side of the grinding head 110 and the power unit. A third bearing 233 is sleeved on the drive shaft 220 at the other side of the grinding head 110.

In the technical solution of the present invention, the second bearing 232 and the third bearing 233 are arranged on both sides of the grinding head 110, which can realize a precise positioning of the grinding head 110, maintain grinding head 110 and the grinding wheel 120 being coaxial, realize precision grinding, grind ultrafine powder and output the powder evenly. At the same time, the first bearing 231 is configured as a flat thrust bearing, which can withstand the axial downward pressure, reduce friction, and maximize kinetic energy efficiency.

The grinding chamber includes a first grinding shell 310, the grinding wheel 120 and the grinding head 110 are arranged in the first grinding shell 310, and the first bearing 231 is arranged between the power unit and the first grinding shell 310.

Specifically, a bearing support 312 is disposed in the first grinding shell 310, and a center of the bearing support 312 defines an opening through which the drive shaft 220 can pass. The bearing support 312 defines a first bearing cavity 313 at a side close to the power unit, and the first bearing 231 is arranged in the first bearing cavity 313. In some specific embodiments, one side of the first bearing 231 abuts against the power unit, and the opposite other side abuts against a bottom wall of the first bearing cavity 313; the output side of the power unit can abut against the first bearing 231 at the same time as the bearing support 312. Since the first bearing 231 is a flat thrust bearing, when the grinding device works, it often exerts a large downward pull on the drive shaft 220, the first bearing 231 (flat thrust bearing) can withstand the axial downward pressure, reduce friction, and maximize kinetic energy efficiency.

The bearing support 312 also defines a second bearing cavity 314 disposed on the side close to the grinding head 110, the second bearing 232 is disposed in the second bearing cavity 314, and the second bearing 232 is located between the bearing support 312 and the grinding head 110.

The first grinding shell 310 is provided with a conical lower concave surface 311 on one side close to the power unit, and a first through hole 3111 is defined at a center of the lower concave surface 311 for the drive shaft 220 and the grinding head 110 to pass through, and the bearing support 312 extends upward from an outer circumference of the first through hole 3111 at a bottom side of the lower concave surface 311. The provision of the lower concave surface 311 can reduce space and make the structure of the first grinding shell 310 more compact.

The grinding wheel 120 is arranged on a lower side of the concave surface 311 of the first grinding shell 310 and is fixed in the first grinding shell 310.

The grinding chamber further includes a second grinding shell 320, and the second grinding shell 320 is sleeved outside the first grinding shell 310.

A mounting bracket 321 is provided in the second grinding shell 320, and the power unit is fixedly mounted on the mounting bracket 321. An axial hole 322 is defined at a center of the mounting bracket 321, and an output end of the power unit and the drive shaft 220 can pass through the axial hole 322. Specifically, the mounting bracket 321 is provided with a power unit mounting surface 323 on the side close to the power unit, and the power unit is fixedly mounted on the power unit mounting surface 323.

The grinding chamber further includes a grinding bottom shell 340, and a bottom of the first grinding shell 310 is mounted in cooperation with the grinding bottom shell 340.

Specifically, the grinding bottom shell 340 has an outer periphery, and the bottom of the first grinding shell 310 is sleeved on the outer side of the outer periphery of the grinding bottom shell 340.

The grinding wheel 120 is fixedly installed between the first grinding shell 310 and the grinding bottom shell 340. In some specific embodiments, the grinding wheel 120 is fixed between the lower concave surface 311 of the first grinding shell 310 and the grinding bottom shell 340.

Specifically, one side of the grinding wheel 120 is against the lower part of the lower concave surface 311 of the first grinding shell 310, and the other side is against a first boss 341 of the grinding bottom shell 340. One side of the grinding head 110 is against an elastic member, and the other side is against an adjusting nut 230.

The grinding bottom shell 340 is provided with the annular first boss 341 and an annular second boss 342, wherein the second boss 342 is provided in the middle of the first boss 341, and a through hole is defined in the center of the second boss 342 for the drive shaft 220 to pass through. A through hole is defined in the center of the second boss 342 for the drive shaft 220 and the adjusting nut 230 to pass through.

A third bearing cavity 344 is defined in the center of the second boss 342, and the third bearing 233 is placed in the third bearing cavity 344. And the third bearing 233 is sleeved outside the adjusting nut 230.

The grinding bottom shell 340 is provided with mounting columns 343 on the periphery of the first boss 341, the first grinding shell 310 is provided with first mounting holes 3112, and the second grinding shell 320 is provided with a mounting bracket 321. The mounting column 343 can pass through the first mounting hole 3112 and cooperate with the mounting bracket 321 of the second grinding shell 320 to be fixed. Specifically, the mounting bracket 321 and the mounting columns 343 may be fixed to each other by means of screws and threaded structures provided on the mounting bracket 321 and the mounting columns 343.

Specifically, the first mounting holes 3112 are defined through the lower concave surface 311 and are located at the periphery of the bearing support 312. Specifically, the height of the first boss 341 is higher than that of the second boss 342.

The grinding head 110 is a conical structure, and its diameter of the side close to the drive assembly is smaller than the diameter of the side away from the drive assembly. By adjusting the axial position of the grinding head 110 in the grinding wheel 120, the gap between inner grinding teeth and outer grinding teeth can be adjusted, thereby adjusting the grinding particle size. The grinding wheel 120 is a through-hole structure, and its inner side wall forms inner grinding teeth; the grinding head 110 is arranged in the middle of the grinding wheel 120, and its outer periphery forms outer grinding teeth that cooperate with the inner grinding teeth to achieve grinding.

The grinding assembly also includes the adjusting nut 230, and an end of the drive shaft 220 extending outside the grinding head 110 is provided with external threads, which cooperate with the adjusting nut 230.

Specifically, the end of the drive shaft 220 extending outside the grinding head 110 is provided with external threads, which cooperate with the adjusting nut 230. The adjusting nut 230 can be rotated to adjust its position on the drive shaft 220, that is, to adjust the distance between the adjusting nut 230 and the driving motor 210. Since the grinding head 110 is located between the adjusting nut 230 and the driving motor 210, the axial position of the grinding head 110 is accordingly adjusted, thereby adjusting the gap between the inner grinding teeth and the outer grinding teeth, and adjusting the grinding particle size. Specifically, an outer wall of the adjusting nut 230 is provided with lugs 231 for easy operation.

An elastic member is sleeved on the drive shaft 220 between the grinding head 110 and the power unit. To maintain the stability of the grinding head 110, one side of the second bearing 232 is against a bottom wall of the second bearing cavity 314 of the bearing support 312, and the other side is against one end of the elastic member, and the other end of the elastic member is against the grinding head 110.

When the adjusting nut 230 adjusts its axial position, the elastic member is elastically adjusted accordingly, thereby maintaining the stable positioning of the grinding head 110 and the stable cooperation with the grinding wheel 120. In a specific embodiment, the elastic member can be a spring, and its opposite ends are respectively in contact with the second bearing 232 and the grinding head 110.

The grinding chamber further includes a drive housing 240, which is fixedly mounted on the mounting bracket 321, and the power unit is arranged in the drive housing 240.

The grinding chamber further includes a third grinding shell 330, which is sleeved outside the first grinding shell 310 and the second grinding shell 320.

The multi-bearing grinding device further includes a control assembly, which is arranged in the grinding chamber. Specifically, it is arranged in the first grinding shell 310.

The control assembly includes a control circuit module 350 and a power supply module. The control circuit module 350 and the power supply module are arranged around a periphery of the grinding wheel 120, specifically, are located in the space enclosed by the grinding wheel 120, the grinding bottom shell 340, and the first grinding shell 310.

Specifically, the control circuit module 350 includes an annular PCB, and the annular PCB is positioned around the grinding wheel 120. The annular PCB is fixed between the mounting columns 343 of the grinding bottom shell 340 and the mounting bracket 321 of the second grinding shell 320. Specifically, the annular PCB can be installed between the mounting columns 343 of the grinding bottom shell 340 and the mounting bracket 321 of the second grinding shell 320 by screws and holes.

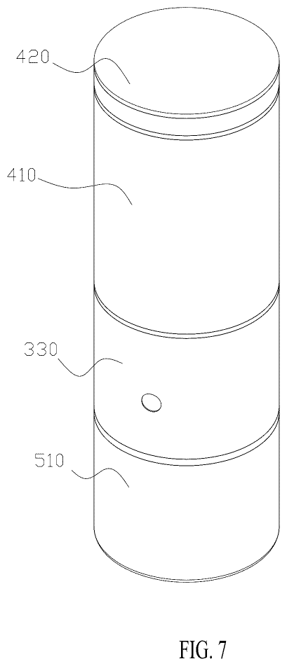

Please refer to FIGS. 1 to 7, the coffee machine of the present invention includes the multi-bearing grinding device as described above, as well as a storage chamber and a powder bin. The storage chamber and the powder bin are respectively arranged on both sides of the grinding chamber and are connected and installed with the grinding chamber. The storage chamber and the powder bin communicate with the grinding chamber.

The drive assembly is arranged in the storage chamber, and the storage chamber provides a bean storage space for storing coffee beans.

The coffee machine of the present invention arranges the drive assembly in the storage chamber, the drive assembly can be highly integrated and only takes up a small space, then the other larger space in the storage chamber can be fully utilized to place coffee beans, which maximize the space. The bean storage space of the grinding device of the present invention is several times larger than that of the traditional grinding device of the same size. Moreover, when it is necessary to fill coffee beans, it is only necessary to open the storage chamber to conveniently put the coffee beans in, and the grinding device and coffee machine of the present invention make adding coffee beans easier and more convenient.

The drive assembly is placed in the center of the storage chamber, and the bean storage space includes an annular space surrounding the drive assembly. The drive assembly is placed in the center of the storage chamber, can be directly connected to and drive the grinding assembly, reducing some parts required for power transmission and conversion, and making the structure of the coffee machine more compact. The drive assembly and the grinding assembly occupy less space, and the space utilization rate is higher.

The drive assembly includes a drive motor 210 longitudinally arranged in the storage chamber, and the drive motor 210 is arranged in a direction coaxial with the drive shaft 220.

The storage chamber includes a storage shell 410 and a storage cover 420, and the bean storage space is formed between the storage shell 410 and the drive assembly. The storage cover 420 is detachably installed at one end of the storage shell 410, and the other end of the storage shell 410 is connected to the second grinding shell 320.

Specifically, the bean storage space also includes the space above the drive assembly and between the drive assembly and the storage cover 420. The storage cover 420 can be directly matched with the storage shell 410 in a snap-on or threaded manner. When need to add coffee beans, simply open the storage cover 420. The bean storage space includes the space left between the storage cover 420 and the drive assembly, that is, the space around and above the drive assembly in communication can be used as a bean storage space, and the space utilization rate is greatly optimized. In some more specific embodiments, the storage shell 410 can be cylindrical. The storage shell 410 can be made of transparent or translucent material, which is more convenient to observe the amount of remaining coffee beans.

The powder bin includes a powder bin shell, and the powder bin shell is installed in conjunction with the first grinding shell 310 and the grinding bottom shell 340.

The grinding device of the present invention is provided with the first bearing 231, the second bearing 232 and the third bearing 233. Specifically, bearings are provided on both sides of the grinding head 110, respectively, so as to realize accurate positioning of the grinding head 110, maintain the coaxiality of the grinding head 110 and the grinding wheel 120, realize precision grinding, and achieve grinding ultrafine powder, and ensure the uniformity of powder output. At the same time, the first bearing 231 is a flat thrust bearing, which can withstand the axial downward pressure, reduce friction, and maximize the kinetic energy efficiency.

The coffee machine of the present invention sets the drive assembly in the storage chamber, and its output end can be directly connected to the grinding assembly in the grinding chamber, so that the drive assembly can be highly integrated and only takes up a small space, then the other larger space in the storage chamber can be fully utilized to place coffee beans, therefore, the space can be maximized, the bean storage space of the grinding device of the present invention is several times larger than the bean storage space of the conventional grinding device of the same size. In addition, when need to add coffee beans, just open the storage chamber and add the coffee beans in it easily, without the need to remove and reinstall the large and bulky main chamber with the control assembly and the grinding assembly as conventional grinding devices, and the coffee bean grinding device of the present invention is simpler and easier to add coffee beans. The control assembly of the present invention can be arranged by making full use of the space around the grinding assembly, thereby maximizing the space utilization.

The above is only a preferred embodiment of the present invention, and the protection scope of the present invention is not limited thereto. Any equivalent transformation based on the technical solution of the present invention belongs to the protection scope of the present invention.

1. A multi-bearing grinding device, comprising:
a grinding chamber;
a drive assembly; and
a grinding assembly, arranged in the grinding chamber, the comprising a grinding wheel and a grinding head that cooperate with each other to obtain grinding;
wherein the drive assembly comprises a power unit and a drive shaft, an output end of the power unit is connected to the drive shaft, the drive shaft is connected to and drives the grinding head to rotate, a first bearing and a second bearing are sleeved on the drive shaft between one side of the grinding head and the power unit, and a third bearing is sleeved on the drive shaft at the other side of the grinding head.

2. The multi-bearing grinding device of claim 1, wherein the grinding chamber comprises a first grinding shell, the grinding wheel and the grinding head are arranged in the first grinding shell, and the first bearing is arranged between the power unit and the first grinding shell.

3. The multi-bearing grinding device of claim 2, wherein the first grinding shell is provided with a bearing support, and a center of the bearing support defines an opening through which the drive shaft passes.

4. The multi-bearing grinding device of claim 3, wherein the bearing support forms a first bearing cavity at a side close to the power unit, and the first bearing is located in the first bearing cavity.

5. The multi-bearing grinding device of claim 4, wherein the bearing support further comprises a second bearing cavity at a side close to the grinding head, the second bearing is located in the second bearing cavity, and the second bearing is located between the bearing support and the grinding head.

6. The multi-bearing grinding device of claim 3, wherein the first grinding shell forms a conical concave surface on a side thereof close to the power unit, a center of the conical concave surface defines a first through hole for the drive shaft and the grinding head to pass through, and the bearing support extends upward from a bottom side of the conical concave surface at an outer circumference of the first through hole.

7. The multi-bearing grinding device of claim 6, wherein the grinding wheel is arranged on the lower side of the conical concave surface of the first grinding shell and is fixed in the first grinding shell.

8. The multi-bearing grinding device of claim 2, wherein the grinding chamber further comprises a second grinding shell, and the second grinding shell is sleeved outside the first grinding shell;
a mounting bracket is formed in the second grinding shell, the power unit is fixedly mounted on the mounting bracket, an axial hole is defined in a center of the mounting bracket, and the output end of the power unit and the drive shaft pass through the axial hole.

9. (canceled)

10. The multi-bearing grinding device of claim 8, wherein the grinding chamber further comprises a grinding bottom shell, a bottom of the first grinding shell is mounted in cooperation with the grinding bottom shell, and the grinding wheel is fixedly mounted between the first grinding shell and the grinding bottom shell.

11. The multi-bearing grinding device of claim 10, wherein the grinding bottom shell forms an annular first boss and an annular second boss, the second boss is provided in a middle of the first boss, and a through hole is provided in a center of the second boss for allowing the drive shaft to pass through.

12. The multi-bearing grinding device of claim 11, wherein a third bearing cavity is formed in a middle of the second boss, and the third bearing is arranged in the third bearing cavity.

13. The multi-bearing grinding device of claim 11, wherein the grinding bottom shell is provided with mounting columns along an outer periphery of the first boss, the first grinding shell defines first mounting holes, the second grinding shell is provided with the mounting bracket, and each mounting column passes through each first mounting hole and cooperate with the mounting bracket of the second grinding shell to be fixed.

14. (canceled)

15. The multi-bearing grinding device of claim 1, wherein the grinding assembly further comprises an adjusting nut, and an end of the drive shaft extending outside the grinding head is provided with external threads, which cooperate with the adjusting nut; an axial position of the grinding head is adjustable by rotating the adjusting nut, thereby a gap between the grinding wheel and a grinding head is adjustable for adjusting a grinding particle size.

16. The multi-bearing grinding device of claim 15, wherein an elastic member is sleeved on the drive shaft between the grinding head and the power unit; when the axial position of the grinding head is adjusted, the elastic member is elastically adjusted accordingly, thereby maintaining a stable positioning of the grinding head and a stable cooperation between the grinding head and the grinding wheel.

17. The multi-bearing grinding device of claim 9, wherein the grinding chamber further comprises a drive housing, the drive housing is fixedly mounted on the mounting bracket, and the power unit is arranged in the drive housing; the grinding chamber further comprises a third grinding shell, and the third grinding shell is sleeved outside the first grinding shell and the second grinding shell.

18. (canceled)

19. A coffee machine, comprising:
a storage chamber;
a powder bin; and
a multi-bearing grinding device, comprising:
a grinding chamber;
a drive assembly, comprising:
a power unit; and
a drive shaft; and
a grinding assembly, arranged in the grinding chamber, comprising:
a grinding wheel; and
a grinding head, cooperated with the grinding wheel for grinding;
wherein an output end of the power unit is connected to the drive shaft, the drive shaft is connected to and drives the grinding head to rotate, a first bearing and a second bearing are sleeved on the drive shaft between one side of the grinding head and the power unit, a third bearing is sleeved on the drive shaft at the other side of the grinding head; the storage chamber and the powder bin are respectively arranged on both sides of the grinding chamber and are connected and installed with the grinding chamber, and the storage chamber and the powder bin are communicated with the grinding chamber.

20. The coffee machine of claim 19, wherein the storage chamber comprises a storage shell, which is installed in cooperation with the first grinding shell or the second grinding shell; the powder bin comprises a powder bin shell, which is installed in cooperation with the first grinding shell; the drive assembly is arranged in the storage chamber, and a storage space for coffee beans is reserved in the storage chamber.

21. The coffee machine of claim 19, wherein the drive assembly comprises a drive motor axially arranged in the storage chamber; and the drive motor is arranged along the same axis as the drive shaft, is directly connected to and drive the grinding assembly; the storage chamber further comprises a storage cover, the storage cover is detachably installed at one end of the storage shell; the storage shell is made of transparent or translucent material.

22. The multi-bearing grinding device of claim 1, wherein the grinding wheel is a through-hole structure, an inner side wall of the grinding wheel forms inner grinding teeth; the grinding head is a conical structure and is arranged in a middle of the grinding wheel, and an outer periphery of the grinding head forms outer grinding teeth that cooperate with the inner grinding teeth to achieve grinding; an axial position of the grinding head in the grinding wheel is adjustable, a gap between the inner grinding teeth and the outer grinding teeth is adjustable accordingly, thereby a grinding particle size is adjustable; an end of the drive shaft extending outside the grinding head is provided with an adjusting nut, the axial position of the grinding head is adjusted by rotating the adjusting nut.

23. The multi-bearing grinding device of claim 1, further comprising an annular PCB, and the annular PCB is installed around the grinding wheel; wherein the grinding head is a conical structure, and diameters of the grinding head of a side close to the drive assembly are smaller than diameters of a side away from the drive assembly.
